(19) United States
(12) Patent Application Publication
(10) Pub. No.: US 2026/0366180 A1
(43) Pub. Date: Nov. 19, 2026

(54) Hybrid electrolysis plant, electrolysis system and method for controlling the power of a hybrid electrolysis plant

(71) Applicant: Siemens Energy Global GmbH & Co. KG, München (DE)

(72) Inventors: Marvin Bendig, Zirndorf (DE); Fisnik Loku, Nürnberg (DE)

(21) Appl. No.: 19/477,571

(22) PCT Filed: Apr. 8, 2024
(86) PCT No.: PCT/EP2024/059423

§ 371 Date: Oct. 22, 2025

(30) Foreign Application Priority Data
Apr. 25, 2023 (DE) 102023203773.4

(51) Int. Cl. C25B 15/02; C25B 1/04

(52) U.S. Cl. CPC C25B 15/02; C25B 1/04

(57) ABSTRACT

The invention provides a method for controlling power in a hybrid electrolysis plant comprising an alkaline electrolyzer and a PEM electrolyzer, both connected in parallel to a supply line. Input power (PE) is supplied, and output power (PA) is drawn from the plant, with continuous monitoring to maintain balance between PE and PA. If an imbalance occurs, PA is adjusted to match PE by controlling the output of the alkaline electrolyzer (P1) and/or the PEM electrolyzer (P2), each with distinct rates of power change (R1 for the alkaline electrolyzer, R2 for the PEM electrolyzer). The invention further encompasses a hybrid electrolysis plant and an electrolysis system incorporating these features.

### BACKGROUND

The invention relates to a hybrid electrolysis plant, to an electrolysis system comprising the electrolysis plant and to a method of power control of the hybrid electrolysis plant.

At present-driven by climate change-there are considerable efforts to cover the largest possible share of society's total energy needs from renewable energy sources. For instance, the Federal Government of the Federal Republic of Germany in 2010 agreed an energy concept which, among other measures, envisages a share of renewable energies of 80% of gross electricity consumption by 2050. In 2017, that share was 36%. A large portion thereof (24.2%) was generated by wind turbines on land and sea, and by photovoltaic systems. However, wind power and photovoltaic systems in particular are highly dependent on weather conditions and/or fluctuations in insolation according to the time of day and year. Thus, power generation by these systems is not guided by current demand, but by the current environmental conditions. As a result, there is a need for energy storage technologies in order to compensate for these differences.

The electrochemical production of hydrogen from water constitutes such a storage technology since, in this way, unusable electrical energy, for example from temporary overproduction, can be chemically bound in hydrogen, stored, transported and released again for use elsewhere. One field of intensified research activity has therefore been in electrolyzers for water electrolysis for this purpose. One possible technology path for water electrolysis is, for example, PEM electrolysis (PEM: “polymer electrolyte membrane”, also known as “proton exchange membrane”) of water. In such PEM electrolyzers, the hydrogen produced is typically obtained in a two-phase stream with recirculated water, from which it first has to be separated before being sent to further use. Another type of electrolysis of water is alkaline electrolysis, in which, for example, potassium hydroxide KOH is supplied to the electrolyzer in concentrated aqueous solution as reactant. Additionally known are high-temperature and high-pressure electrolyses. Also known are mixed forms of electrolysis, for instance anion exchange membrane electrolysis, also referred to as AEM electrolysis for short.

Electrolysis is a well-known electrochemical method in which an electric direct current (DC) is used to drive an otherwise non-spontaneous chemical reaction. Another reason why electrolysis has recently gained increased attention as a technological approach in the fight against climate change is that it can be used in so-called “power-to-X” processes. This generally involves converting a supply medium as reactant, e.g. water or CO₂, to chemical energy by means of renewable electrical energy through electrolysis. The electrolysis products as materials of value that contain this energy are diverse and range, for example, from hydrogen H₂ with O₂ as by-product through hydrocarbons such as methane CH₄, also referred to as “synthetic natural gas” SNG or synthetic LNG in liquid form, ethylene C₂H₄ or ethanol C₂H₅OH, up to ammonia NH₃ or carbon monoxide CO. These molecules can be used as fuel, for example for vehicles or generators, or as a starting material for the chemical industry.

In general, the electrolysis process has to be supplied with predictable and very substantially constant or uniform power input, while the generation of renewable energies is known to provide fluctuating power for various reasons. For example, the amount of energy generated depends on weather conditions or the position of the sun, for instance when the electrolysis power is provided by a wind turbine or photovoltaic system. In addition, the amount of energy generated depends on both the current season and the time of day. In order to protect electrolysis cells from damage caused by input power fluctuations, they have to be operated in such a way that, as far as possible, no energy deficiency occurs during operation. For this purpose, the power generated cannot be consumed completely, and portions have to be discarded. For example, in the case of a surplus line on the producer side, the wind turbine is restricted. This control intervention on the producer side is called “wind curtailment” in a wind turbine.

### SUMMARY

It is an object of the present invention to improve the efficiency of the electrolysis process with regard to a fluctuating supply of electrical power for electrolysis, in particular in the case of operation in an isolated network.

This object is achieved in accordance with the invention by a method of power control in a hybrid electrolysis plant which is connected to a supply line and comprises an alkaline electrolyzer and a PEM electrolyzer connected to the supply line in parallel to the alkaline electrolyzer, wherein an electrical input power is fed into the supply line and an electrical output power is taken from the hybrid electrolysis plant by the supply line, while monitoring a balance between the input power and the output power and, in the event of an imbalance, adjusting the output power to the input power by controlling a first output power of the alkaline electrolyzer and/or a second output power of the PEM electrolyzer, where the control of the alkaline electrolyzer involves employing a first rate of change in the power over time and employing a second rate of change in the power over time in the PEM electrolyzer.

This object is also achieved by a hybrid electrolysis plant and an electrolysis system.

The invention proceeds from the finding that electrolysis plants are particularly suitable for production of green hydrogen. The two technologies available on the market are alkaline electrolysis and proton exchange membrane electrolysis, also known as PEM electrolysis. However, the two electrolyses and the electrolyzers to be provided for the purpose are distinctly different in terms of costs and the possible operating dynamics in the event of load changes. While alkaline electrolyzers, which have been available on the market for some time, are less costly, alkaline electrolyzers can only very gradually change the power consumption of the direct electrolysis current. The alkaline systems are therefore suitable only to a limited degree for direct coupling to volatile generation plants, for example to wind farms, PV parks, etc., because they cannot follow the performance profile of the generation sufficiently quickly. PEM electrolyses, on the other hand, can be controlled much more dynamically and are therefore of better suitability for use in combination with volatile generators. However, these advantages are associated with higher costs in a PEM electrolysis.

Economic coupling of volatile power generation plants with hydrogen production plants such as electrolyzers can be achieved by a combination of the two electrolysis technologies. The alkaline electrolysis assumes the baseload, while the PEM system tracks the dynamic loads, so as to result in a hybrid electrolysis plant.

In terms of control, the invention now meets the technical challenges of controlling the hybrid electrolysis plant with a correspondingly adapted rectifier control in such a way that the load is divided between the electrolysis systems in such a way that the PEM electrolysis tracks rapid changes and the alkaline electrolysis is run or remains in a very substantially constant load range. Since the profile of the feed-in energy can be predicted only to a limited degree, the control adjustment by the power control system takes place at the level of the individual systems “in situ”, i.e. during operation, without knowledge of the future load profile or at least with a foreseeably high forecast uncertainty. The electrolysis process individually controlled in this way, for example via the respective mains rectifiers for an alkaline electrolysis and for a PEM electrolysis, is advantageously designed here overall as a hybrid combination of an alkaline electrolysis and a PEM electrolysis.

This achieves the effect that, in the case of island operation of wind farms, for example, when the surplus power cannot be consumed, the wind power restriction, a disadvantageous “wind curtailment”, no longer has to be applied, or has to be applied only in exceptional cases and only to a small extent. This results in cost benefits. This manner of implementation of a separate power control system with respective characteristic power transients for the alkaline electrolyzer and the PEM electrolyzer implemented in the control system results in considerable cost benefits through the adjusted mode of operation of the hybrid electrolysis process. Here, for example, the power control is implemented as power control for a respective rectifier via which the alkaline electrolyzer and the PEM electrolyzer are connected to the supply line.

What is thus proposed is an approach that overcomes the disadvantages of the prior art in relation to hybrid alkaline PEM electrolysis plants, with efficiency benefits resulting from the rectifier control.

In the power control system of the invention, any imbalance between the output power and the input power is constantly monitored and imbalances are corrected in that a respective adapted load control for the alkaline electrolyzer and the PEM electrolyzer is implemented. It is possible that the input power is provided in the supply line as AC input power or as DC input power. The supply line is then designed as a central AC supply line or correspondingly as a DC supply line, such that operation in an AC grid or a DC grid is flexibly possible.

What is proposed here is to implement a power control system that uses a physical variable that represents a power imbalance at the grid connection point of the hybrid electrolysis plant as control input variable and continuously monitors this variable. In AC networks this is preferably the mains frequency of the AC network, and in DC networks the DC voltage. If there is an imbalance between the input power fed in and the output power accepted, there will be a change in this control input variable. In an AC grid, for example, there may be an increase in the mains frequency if the input power is greater than the output power. In a DC grid, there would be an increase in the mains voltage in this case.

As a result, there is then a increase, for example, in the first output power and the second output power. In this case, the power control system is implemented in such a way that the alkaline electrolyzer and the PEM electrolyzer have respectively preset and adjustable rates of change of power in a transient mode of operation that differ greatly from one another. In the event of a power imbalance, the second output power is preferably altered significantly faster for the PEM electrolyzer than for the first rate of change of power in the alkaline electrolyzer. This limitation or definition of the operating intervals for specific rates of change of power removes volatile components from the PEM system in a controlled manner, while the first power supply in the case of the alkaline electrolyzer is barely adjusted in the event of brief changes in power. A new operating point of the alkaline electrolyzer is only tracked with a considerable time delay.

However, if a power imbalance exists over a longer time interval, adjustment and tracking of the alkaline electrolyzer is also implemented at a new operating point, so as advantageously to bring about an adjusted, e.g. increased, reduction in baseload on the part of the alkaline electrolyzer. This approach allows combination and operation of alkaline and PEM systems in a hybrid electrolysis plant without directly coupling the respective power control system. Such a control concept is therefore also easily extendable here in that further electrolyzers are connected.

It is found particularly advantageously that the control concept results in controlled distribution of fluctuations in input power, i.e. caused by the producer side, over the electrolysis plant between the alkaline electrolyzer and the PEM electrolyzer through appropriate current supply. In this way, fluctuations and imbalances in the power balance can be significantly reduced or buffered depending on the respectively predetermined first and second rates of change of power. In this way, a corresponding hybrid electrolysis plant is empowered to consume the volatile renewable input power generated almost completely for electrolysis purposes, in spite of occurrence of fluctuations, so as to increase efficiency with regard to the volatile renewable energy utilizable for electrolysis purposes.

In an embodiment of the method, the first output power is accepted via a first rectifier and fed as DC power to the alkaline electrolyzer, and the second output power accepted via a second rectifier and fed to the PEM electrolyzer.

In this case, controllable and regulatable rectifiers are used as first and second rectifier, such that an individual regulation and control of the first output power and the second output power is implementable at the respective grid connection point of the electrolyzers. For example, phase gating control for the power control system can be implemented in the rectifiers. In this way, a means of connection and a flexibly adjustable power control system are advantageously provided in a supply line designed as an AC grid via a respectively independent rectifier control for the alkaline electrolyzer and the PEM electrolyzer.

In the method, the second rate of change of power of the second rectifier is preferably set at a higher level than the first rate of change of power of the first rectifier.

As a result, solely by means of one rectifier control system, the respective output power in both rectifiers—the first rectifier of the alkaline electrolyzer and the second rectifier of the PEM electrolyzer—is adjusted and tracked with a specific rate of change of power. As a result of the differences envisaged in the respectively defined rates of change of power, in the event of an imbalance, the second output power of the second rectifier in the PEM electrolyzer is changed significantly faster than that via the first rectifier in the alkaline electrolyzer. This limitation of the rates of change results in automatic acceptance of volatile components primarily by the PEM system through the power control system, while the alkaline system barely reacts to brief changes in power.

In an embodiment of the method, it is proposed that the second rate of change of power be set at least 20 times higher, preferably at least 40 times and more preferably at least 60 times higher than the first rate of change of power.

This enables immediate consumption and near-instantaneous tracking of a detected change in input power primarily by the PEM electrolyzer. Additional devices for accepting or buffering these changes, for example capacitors or batteries, can be avoided or made distinctly smaller.

For a further embodiment of the method, it is envisaged that the first rate of change of power is set within a range of values of 5% to 15% per minute with respect to the rated power of the alkaline electrolyzer. In one embodiment, for a transient, a range of values of 7% to 13% per minute with regard to the rated power of the alkaline electrolyzer can be set or run through.

In this context, the rated power is the highest electrical peak power as the maximum output power that may be provided for sustained operation of the corresponding electrolyzer. This load profile for power control and in transient operation is adapted to alkaline electrolysis cells as installed in large numbers in an alkaline electrolysis plant. Such electrolysis cells with this load profile are frequently used because they are inexpensive to manufacture and offer good baseload capabilities.

For a further embodiment of the method, it is proposed that the second rate of change of power be set within a range of values of 5% to 15% per second with respect to the rated power of the PEM electrolyzer. In one embodiment, for a transient, a range of values of 7% to 13% per second with regard to the rated power of the PEM electrolyzer can be set or run through.

For example, this load profile can be implemented by means of an electrolyzer with an electrolysis cell having a proton exchange membrane or an anion exchange membrane. In particular, the electrolysis electrodes of said electrolysis cells are deposited directly on the conductive membrane. By contrast with conventional electrolysis cells, for example with alkaline electrolysis, the proton or anion exchange membrane enables very rapid adjustment of a production rate and hence adjustment of the second output power to a change in the input power.

In one embodiment, in the method, in the event of a very rapid increase in the input power which is greater than the second rate of change of power, the electrical surplus energy is stored in an energy storage means connected to the supply line.

In order to additionally enable the absorption of very rapid load peaks, short-term grid storage can be provided as an energy storage means, for example designed as an energy storage means based on supercapacitors or on a flywheel storage device. The energy storage means can then be used when required to absorb such high power changes, i.e. very steep short-term transients or peak loads for which even the load change dynamics of a PEM electrolyzer are too slow.

It is proposed with preference in the method that stored energy be taken from the energy storage and fed into the supply line as electrical power.

This enables recovery and utilization of stored energy for electrolysis purposes in the electrolysis plant and hence an additional increase in efficiency. The emptied energy storage means is then ready again for the absorption of load peaks and storage of energy.

In an embodiment of the method, the power is controlled in the hybrid electrolysis plant in such a way that the alkaline electrolyzer is operated at a maximum first output power of at least 70%, preferably more than 80%, of its rated power.

The primary overriding control objective is thus that the alkaline electrolyzer is fully exploited with regard to achievement of a maximum and stable baseload as the operating point of the electrolysis plant, and the first output power is implemented accordingly in the power control system. Thus, longer-term and quasi-stationary input powers are supplied primarily to the alkaline electrolyzer for electrolysis, and this is powered via the controllable and regulatable first rectifier.

This primary control premise, implemented in the power control system, prevents virtually all surplus input power from always being absorbed solely by the PEM electrolyzer and/or the energy storage means. For this purpose, additional higher-level control loops are preferably implemented in the power control system. An envisaged energy storage means as described above should therefore virtually always be empty over the long term, while the alkaline electrolyzer is run in a virtually steady state at maximum first output power and high baseload. These overriding control objectives allow the electrolysis plant to be operated with higher efficiency overall and exploited, for example, for elevated hydrogen production. Changes in power can be tracked and absorbed efficiently in this way.

In addition, in the process, it may preferably be the case that the power is controlled in such a way that forecast data for the input power is consulted regularly and a specific setpoint is defined based on the forecast data for the first output power and the second output power.

An advantageously implementable power control system is, for example, one that consults the wind forecast data or other weather data available at regular intervals—for instance every 15 minutes—and, based on a resulting forecast of the input power, defines the first output power and the second output power as target powers or setpoint powers of the alkaline electrolyzer or the PEM electrolyzer according to a predetermined breakdown. The forecast data is updated on a regular basis and the electrolysis plant is adjusted accordingly.

A further aspect of the invention relates to a hybrid electrolysis plant for performance of the method according to the invention.

The hybrid electrolysis plant comprises an alkaline electrolyzer and a PEM electrolyzer, and a control device designed to implement the method of power control.

The hybrid electrolysis plant comprises an electrolysis cell with a cell structure for alkaline electrolysis and an electrolysis cell with a cell structure for a PEM electrolyzer. The hybrid electrolysis plant may comprises a plurality of electrolysis cells of each of the two types, which can be stacked to form a respective electrolysis module. An alkaline electrolyzer or a PEM electrolyzer may have several electrolysis modules connected in series. In particular, the electrolysis cells are each set up such that they generate an electrolysis product from a supply medium by means of supplied electrical energy. In one embodiment, the electrolysis cells convert the supply medium of water to H₂ and O₂. However, it is also possible that the supply of CO₂ and water as reactants for an electrolysis leads to carbon monoxide CO, small hydrocarbons or small oxygen-containing compounds as electrolysis products.

In an embodiment of the hybrid electrolysis plant, the control device implements rectifier control, such that respective power control of the first rectifier and the second rectifier is implementable.

This advantageously achieves independent load control of the alkaline electrolyzer and the PEM electrolyzer in the integrated system in a hybrid electrolysis plant. Power control and load sharing is individually and independently implemented via the rectifier system with the first rectifier and the second rectifier in the hybrid electrolysis plant by means of a controllable rectifier. The first rectifier and the second rectifier are controllable individually and independently such that the first output power and the second output power are adjustable as DC power at the output of the respective rectifier. Advantageously, for instance, phase gating control may be provided for setting the output power and the individual current supplied. For instance, in a thyristor-based rectifier, the firing pulse of the thyristors can be controlled via a control pulse. After the control pulse has ceased, the current flow remains until the next zero crossing. Moving the switch-on time allows variation of the energy or power that flows to the consumer at the output. But the concept of power control and division of the power between the first rectifier and the second rectifier is not limited to a specific type of implementation of the rectification in a circuit.

In one embodiment, an energy storage means designed as a short-term grid storage means is provided in the hybrid electrolysis plant, and in particular includes a supercapacitor or a flywheel storage device.

This is advantageous in order to additionally enable the absorption of very fast load peaks as required. The energy storage means thus designed can be activated in the event of large changes in power and can absorb those load peaks for which the dynamics of the PEM electrolysis are too slow. Timely feedback of the energy stored in the energy storage means is envisaged, such that the power consumption and power output in the hybrid electrolysis plant can be kept in balance even in the event of a transient change in the input power on the producer side.

The electrolysis system of the invention comprises a hybrid electrolysis plant of the invention.

In addition, the electrolysis system comprises a renewable energy installation that generates electrical energy which is supplied as input power for the operation of the electrolysis device and fed into the supply line. This renewable energy installation may be a photovoltaic plant, a solar thermal power plant and/or a wind turbine. For example, the photovoltaic assembly is constructed as a photovoltaic system consisting of a multitude of photovoltaic modules that each have multiple photovoltaic cells. This enables the use of an autonomous system, called an island network, which can be installed in regions with little or no infrastructure.

The electrolysis system may be configured such that the hybrid electrolysis plant is connected to the renewable energy installation via a supply line designed as a central AC line, forming an island grid.

Further advantages, features and details of the invention will be apparent from the description of preferred working examples that follows and from the drawing. The features and combinations of features cited above in the description and the features and combinations of features cited below in the description of the sole figures and/or shown on their own in the figures are usable not just in the respectively specified combination but also in other combinations or on their own, without departing from the scope of the invention.

### BRIEF DESCRIPTION OF THE DRAWINGS

Working examples of the invention are elucidated in detail by a drawing. These show, in schematic and highly simplified form:

FIG. 1. depicts an electrolysis system comprising a renewable energy installation and a hybrid electrolysis plant.

### DETAILED DESCRIPTION

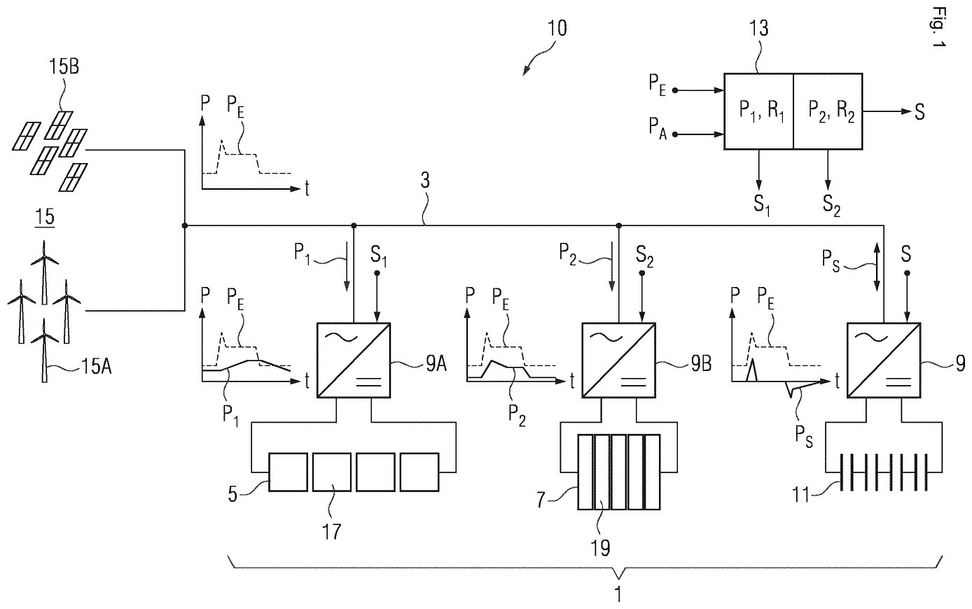

FIG. 1 shows, in schematic illustration, an electrolysis system 10 with a renewable energy installation 15 and with a hybrid electrolysis plant 1. The renewable energy installation 15 has a wind turbine 15A and a photovoltaic plant 15B, such that, in operation, an electrical input power PE obtained from renewable energy production—in the present working example in the form of AC power—is feedable into the supply line 3. The hybrid electrolysis plant 1 comprises an alkaline electrolyzer 5 and a PEM electrolyzer 7, where the electrolyzers 5, 7 are each connected to the central supply line 3 at separate mains connection points. This provides an AC-based island network. In this case, the alkaline electrolyzer 5 is connected to the supply line 3 via a first rectifier 9A and the PEM electrolyzer 7 via a second rectifier 9B, so as to achieve a parallel connection. A respective rectifier 9A, 9B supplies a respective electrolyzer 5, 7 with a controlled DC power for electrolysis. An energy storage means 11 is additionally connected via a further rectifier 9 to the supply line 3 at a separate mains connection point. The alkaline electrolyzer 5 has a number of alkaline electrolysis modules 17 connected in series, each with a multitude of alkaline electrolysis cells. Correspondingly, the PEM electrolyzer 7 comprises a number of series-connected electrolysis modules 19, each with a multitude of PEM electrolysis cells. By virtue of its modularity, the hybrid electrolysis plant 1 is scalable and designed for high PA output capacities and can be extended accordingly.

For power control of the hybrid electrolysis plant 1, a control device 13 is provided, which is designed with regard to control and distribution of the input power PE fed in for achievement of a balance as far as possible with the output power PA of the hybrid electrolysis plant 1. In this case, a specific load control of the consumers involved is implemented in the control device 13, comprising the alkaline electrolyzer 5, the PEM electrolyzer 7 and the energy storage means 11, and individually controls their load over time. For this purpose, the control device 13 supplies a respective control signal S₁, S₂, S at its output, which acts on the respectively assigned rectifier 9A, 9B, 9. The control signal S₁ controls the first rectifier 9A, such that a first output power P₁ defined by the control device 13 is extracted from the supply line 3 and supplied to the alkaline electrolyzer 5 as DC power. Correspondingly, the control signal S₂ controls the second rectifier 9B, such that a second output power P₂ defined by the control device 13 is extracted from the supply line 3 and supplied to the PEM electrolyzer 7 as DC power. In addition, in the event of load peaks on the producer side, electrical energy can be stored temporarily in the energy storage unit 11 with a storage line P_{S} and output again if required into the supply line 3. For this purpose, the rectifier 9 is set up for bidirectional operation and is connected to the mains connection point.

In operation of the electrolysis system 10, an electrical input power P_{E} is fed into the supply line 3 and an electrical output power P_{A} from the hybrid electrolysis plant 1 as a whole is taken from the supply line 3. In this case, a balance between the input power P_{E} and the output power P_{A} is monitored by means of the control device 13, and, in the event of an imbalance, the output power P_{A} is adjusted to the input power P_{E}, with control of a first output power P₁ of the alkaline electrolyzer 5 and/or a second output power P₂ of the PEM electrolyzer 7. The alkaline electrolyzer 5 is controlled with a first rate of change in power over time R₁, and in the PEM electrolyzer 7 a second rate of change in the power over time R₂ is employed. The rate of change of power over time R₂ is several times greater than the rate of change over time R₁, typically in the range of a factor of 20 to 60. Adjusted load control is thus achieved, in which the outcome for the alkaline electrolyzer 5 is that the output power P₁ is varied and adjusted more slowly over time, while the output power P₂ is varied much more quickly for the PEM electrolyzer 7, and hence the PEM electrolyzer 7 can be moved to a changed operating point in a timely manner. The diagrams shown in the figure for the respective rectifier 9A, 9B, 9 show power P versus time t. These show the qualitative progression of the volatile input power P_{E} and the respective progression of the controlled output power P₁, P_{2,}Ps over time according to the rectifier control implemented in the control device 13 in each case. Over time, the control device 13 causes specifically different transients in the output powers P₁, P₂ and the storage power P_{S}, so as to maintain or restore a balance between input power P_{E} and output power P_{A}.

In the case of an increased input power P_{E}, for example, the first output power P₁ taken out and the second output power P₂ are increased for both rectifiers 9A, 9B. The ranges of values implemented for the rates of change of power R₁, R₂ in the power control by the control device 13 are found from the respective derivative dP₁(t)/dt or dP₂(t)/dt—i.e. the change in the respective output power P₁, P₂ per unit time or a so-called power transient. There is a considerable difference in the set ranges of values for the rates of change of power R₁, R₂ that are permissible for operation as a systemic reaction to an altered input power P_{E}—by one to two orders of magnitude-for the alkaline electrolyzer 5 and for the PEM electrolyzer 7. The adjustment and control of the output powers P₁, P₂ is effected via the respective control by the first rectifier 9A and the second rectifier 9B.

In the event that a power imbalance is detected, the control device 13 actuates the second rectifier 9B of the PEM electrolyzer 7 such that the second output power P₂ is altered and adjusted much more quickly in the region of seconds than the first output power P₁ of the first rectifier 9A that supplies the alkaline electrolyzer 5 with DC power. This limitation of the range of values for the rates of change of power R₁, R₂ automatically results primarily in acceptance of volatile components by the PEM electrolyzer 7, while the alkaline electrolyzer 5 barely reacts to short-term changes in power. However, if there is a power imbalance over a longer period of time on a time scale in the region of minutes, according to the rate of change of power R₁, adjustment and tracking is also conducted here on the part of the alkaline electrolyzer 5, such that the alkaline electrolyzer 7 adjusts dynamically to a reduction in baseload. This approach advantageously allows combination of the alkaline electrolyzer 5 and the PEM electrolyzer 7 with one another in the electrolysis system 10 without directly coupling the respective control of the electrolyzers 5, 7. Such an electrolysis system 10 is therefore also easily extendable with regard to a large input line, and scalable in a corresponding manner in an electrolysis plant 1. This load control results in operation of the alkaline electrolyzer 5 in a very substantially continuous and quasi-steady-state manner at a maximum first output power P₁ of more than 70% of its rated power, for example 85%. The PEM electrolyzer 7 is run more dynamically in the event of transients, since the PEM electrolyzer 7 is better designed to react to short-term changes in load. In order to provide a corresponding dynamic power reserve as required for a higher and a lower second output power P₂, the intention is to run the PEM electrolyzer 7 in part-load operation on average over time, for example at an average part-load of 40% to 60% or a high part-load between 60% and 75% of its rated load. A corresponding operating regime for the PEM electrolyzer 7 is implemented in the control device 13, such that a control signal S₂ for the second rectifier 9B is output for DC power supply to the PEM electrolyzer 7. For load control, the control device 13 for power control is enhanced such that forecast data for input power PE can be regularly consulted and read in, so as to ascertain a respective setpoint based on the forecast data for the first output power P₁ and the second output power P₂, and corresponding control signals S₁, S₂ for the rectifiers 9A, 9B of the electrolyzers 5, 7 and, if required, of the rectifier 9 for the operation of the energy storage means P_{S}.

1. A method of power control in a hybrid electrolysis plant which is connected to a supply line and comprises an alkaline electrolyzer and a PEM electrolyzer connected to the supply line in parallel to the alkaline electrolyzer, wherein an electrical input power (PE) is fed into the supply line and an electrical output power (PA) is taken from the hybrid electrolysis plant by the supply line, while monitoring a balance between the input power (PE) and the output power (PA) and, in the-an event of an imbalance, adjusting the output power (PA) to the input power (PE) by controlling a first output power (P1) of the alkaline electrolyzer and/or a second output power (P2) of the PEM electrolyzer, where the control of the alkaline electrolyzer involves employing a first rate of change in the power over time (R1) and employing a second rate of change in the power over time (R2) in the PEM electrolyzer.

2. The method as claimed in claim 1, in which the first output power (P1) is taken via a first rectifier and supplied as DC power to the alkaline electrolyzer, and the second output power (P2) is taken via a second rectifier and fed to the PEM electrolyzer

3. The method as claimed in claim 2, wherein the second rate of change of power (R2) of the second rectifier is set at a higher level than the first rate of change of power (R1) of the first rectifier.

4. The method as claimed in claim 1, wherein the second rate of change of power (R2) is set at least 20 times higher, times than the first rate of change of power (R1).

5. The method as claimed in claim 1, wherein the first rate of change of power (R1) is set within a range of values of 5% to 15% per minute with respect to the rated power of the alkaline electrolyzer.

6. The method as claimed in claim 1, wherein the second rate of change of power (R2) is set within a range from 5% to 15% per second with respect to the rated power of the PEM electrolyzer

7. The method as claimed in claim 1, wherein, in the an event of a very rapid increase in the input power which is greater than the second rate of change of power (R2), the electrical surplus energy is stored in an energy storage means connected to the supply line

8. The method as claimed in claim 7, wherein stored energy is taken from the energy storage means and fed into the supply line as electrical power.

9. The method as claimed in claim 1, wherein the power is controlled in the hybrid electrolysis plant in such a way that the alkaline electrolyzer is operated at a maximum first output power (P1) of at least 70% more than 80%, of its rated power.

10. The method as claimed in claim 9, wherein the power control is implemented in such a way that forecast data for the input power (PE) is consulted regularly and a specific setpoint is defined based on the forecast data for the first output power (P1) and the second output power (P2).

11. A hybrid electrolysis plant comprising an alkaline electrolyzer and a PEM electrolyzer, and a control device designed to implement the method of power control as claimed in claim 1.

12. The hybrid electrolysis plant as claimed in claim 11, wherein the control device (implements rectifier control, such that a respective power control of a first rectifier and a second rectifier is implementable.

13. The hybrid electrolysis plant as claimed in claim 11, having an energy storage means which includes a supercapacitor or a flywheel storage device.

14. An electrolysis system comprising:
a hybrid electrolysis plant as claimed in claim 11;
a renewable energy installation that generates electrical energy which is supplied as input power (PE) for an operation of an electrolysis device and fed into the supply line.

15. The electrolysis system as claimed in claim 14, wherein the hybrid electrolysis plant is connected to a renewable energy system via a supply line designed as a central AC line, forming an island grid.
